(19) United States
(12) Patent Application Publication
(10) Pub. No.: US 2014/0139256 A1
(43) Pub. Date: May 22, 2014

(54) DETECTING DEVICE AND METHOD FOR LIQUID CRYSTAL PANEL

(71) Applicant: SHENZHEN CHINA STAR OPTOELECTRONICS TECHNOLOGY CO. LTD., Shenzhen, Guangdong (CN)

(72) Inventors: Hao Huang, Shenzhen (CN); Chun Liu, Shenzhen (CN); Chang-hung Pan, Shenzhen (CN)

(73) Assignee: SHENZHEN CHINA STAR OPTOELECTRONICS TECHNOLOGY CO. LTD., Shenzhen, Guangdong (CN)

(21) Appl. No.: 13/813,935

(22) PCT Filed: Nov. 30, 2012
(86) PCT No.: PCT/CN12/85635

§ 371 Date: Feb. 1, 2013

(30) Foreign Application Priority Data
Nov. 20, 2012 (CN) 201210472359.X

(51) Int. Cl. G09G 3/00

(52) U.S. Cl. CPC G09G 3/006
USPC 324/760.02

(57) ABSTRACT

A detecting device for detecting a liquid crystal panel is provided. The detecting device includes a first detecting unit connected to data lines on the liquid crystal panel, a second detecting unit connected to scanning lines on the liquid crystal panel, and a signal generator connected to the first detecting unit and the second detecting unit; both the first detecting unit and the second detecting unit comprise a line area and connecting ports arranged on one side of the line area and connected to the signal generator; a plurality of lines are arranged on the line area, the lines having the same properties are connected together with one ends thereof respectively connected to the connecting ports and the other ends thereof connected to the corresponding signal lines arranged on the liquid crystal panel.

### BACKGROUND

1. Technical Field

The present disclosure relates to liquid crystal displaying technologies and, particularly, to a detecting device and a detecting method used for detecting a liquid crystal.

2. Description of Related Art

With the development of electronic technology, flat displays such as liquid crystal displays, plasma displays, and OLED displays (Organic Light-Emitting Diode) have gained rapid development. Among the flat displays, liquid crystal displays are thin, small and energy-efficient, making liquid crystal displays gradually replace code cathode displays.

TFT-LCD is a type of flat displays commonly used. Generally, the lighting detection way of the TFT-LCD includes 2D1G (units formed by two data lines and one gate line) and 3D2G (units formed by three data lines and two gate lines). However, detecting the TFT-LCD in the 2D1G and 3D2G ways may cause two adjacent data lines to have same polarities, which weakens the detecting ability of the liquid crystal panel. Referring to FIGS. 1 and 2, in which FIG. 1 is a schematic view illustrating a circuit structure for carrying out lighting detection in the 3D2G way and FIG. 2 is a schematic view illustrating detecting signals and the detecting result when using the circuit structure of FIG. 1 to carry out the lighting detecting. Take the 3D2G lighting detection way as an example, every three data lines forms a unit, first data lines of all the units are connected together to receive R signals, second data lines of all the units are connected together to receive G signals, and third data lines of all the units are connected together to receive B signals. Every two scanning lines forms a unit, first scanning lines of all the units are connected together to receive G1 signals, and second scanning lines of all the units are connected together to receive G2 signals. In the detecting process, the R signal, G signal, B signal, G1 signal, and the G2 signal are shown as FIG. 2. According to the obtained DOT electrical state, the DOT receiving the R signal and the B signal for detection has the same electrical property, which weakens the detecting ability of the liquid crystal panel.

### SUMMARY

The present disclosure provides a detecting device for detecting a liquid crystal panel which is capable of sharpening the competitive edge of products with liquid crystal panels and improving the detecting ability of the liquid crystal panel.

The detecting device includes a first detecting unit connected to data lines on the liquid crystal panel, a second detecting unit connected to scanning lines on the liquid crystal panel, and a signal generator connected to the first detecting unit and the second detecting unit; both the first detecting unit and the second detecting unit include a line area and connecting ports arranged on one side of the line area and connected to the signal generator; a plurality of lines are arranged on the line area, the lines having the same properties are connected together with one ends thereof respectively connected to the connecting ports and the other ends thereof connected to the corresponding signal lines arranged on the liquid crystal panel.

Preferably, the lines arranged on the line area form at least two groups of line units, the lines in each group of line unit are arranged according to property and the sequence of the lines in each group of line unit is identical to each other, and the number of the lines in each group of line unit is equal to that of the connecting ports.

Preferably, the number of the connecting ports of the first detecting unit is 4, and the number of the lines arranged on the line area is 4n, wherein n is an integer greater than or equal to 2; the number of the connecting ports of the second detecting unit is 2, the number of the lines arranged on the line area is 2n, wherein n is an integer greater than or equal to 2.

Preferably, the number of the connecting ports of the first detecting unit is 6, and the number of the lines arranged on the line area is 6n, wherein n is an integer greater than or equal to 2; the number of the connecting ports of the second detecting unit is 4, the number of the lines arranged on the line area is 4n, wherein n is an integer greater than or equal to 2.

Preferably, the number of the connecting ports of the first detecting unit is 6, and the number of the lines arranged on the line area is 6n, wherein n is an integer greater than or equal to 2; the number of the connecting ports of the second detecting unit is 2, the number of the lines arranged on the line area is 2n, wherein n is an integer greater than or equal to 2.

Preferably, the numbers of the connecting ports of the first detecting unit and the second detecting unit are respectively 4, the number of the lines arranged on the line area 4n, wherein n is an integer greater than or equal to 2.

Preferably, the detecting device further includes a first transferring plate connected between the signal generator and the first detecting unit and a second transferring plate connected between the signal generator and the second detecting unit.

The present disclosure further provides a detecting method for detecting a liquid crystal panel by using the detecting device in claim 1, including:

providing a to-be-detected liquid crystal panel and cutting off a short circuit ring disposed on a non-displaying area of the liquid crystal panel to reveal ends of data lines and scanning lines on the liquid crystal panel;

connecting the first detecting unit of the detecting device to the ends of the data lines and connecting the second detecting unit of the detecting device to the ends of the scanning lines; and

controlling the signal generator to continuously generate a first detecting signal and a second detecting signal to detect the liquid crystal panel.

Preferably, the lines arranged on the line areas of the first detecting unit and the second detecting unit form at least two groups of line unit, the lines in each group of line unit are arranged according to property and the sequence of the lines in each group of line unit is identical to each other, and the number of the lines in each group of line unit is equal to that of the connecting ports.

Preferably, the number of the connecting ports of the first detecting unit is 6, and the number of the lines arranged on the line area is 6n, wherein n is an integer greater than or equal to 2; the number of the connecting ports of the second detecting unit is 4, the number of the lines arranged on the line area is 4n, wherein n is an integer greater than or equal to 2.

Preferably, the number of the connecting ports of the first detecting unit is 4, and the number of the lines arranged on the line area is 4n, wherein n is an integer greater than or equal to 2; the number of the connecting ports of the second detecting unit is 2, the number of the lines arranged on the line area is 2n, wherein n is an integer greater than or equal to 2.

Preferably, the number of the connecting ports of the first detecting unit is 6, and the number of the lines arranged on the line area is 6n, wherein n is an integer greater than or equal to 2; the number of the connecting ports of the second detecting unit is 2, the number of the lines arranged on the line area is 2n, wherein n is an integer greater than or equal to 2.

Preferably, the numbers of the connecting ports of the first detecting unit and the second detecting unit are respectively 4, the number of the lines arranged on the line area 4n, wherein n is an integer greater than or equal to 2.

Preferably, the detecting device further includes a first transferring plate disposed between the signal generator and the first detecting unit and a second transferring plate disposed between the signal generator and the second detecting unit.

The line areas of the detecting device of the present disclosure are respectively configured with lines, and one end of each line area is configured with connecting ports for receiving detecting signals and the other end of each line area is connected to signal lines on the liquid crystal panel, which can converting the lighting detection way of the liquid crystal panel. Additionally, after the lighting detection of the liquid crystal panel is finished, the detecting device is detached to be recycled, which not only improves the detecting ability of the liquid crystal panel but also reduces the area of the circuit on the liquid crystal panel and further sharpens the competitive edge of the liquid crystal panel.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view illustrating a circuit structure for carrying out a lighting detection in the 3D2G way;

FIG. 2 is a schematic view showing detecting signals and detecting result when using the circuit structure of FIG. 1 to carry out the lighting detection;

FIG. 3 is a schematic view illustrating a detecting device for detecting a liquid crystal panel in accordance with an embodiment of the present disclosure;

FIG. 4 is a partially schematic view of the detecting device in which the number of the connecting ports is 2;

FIG. 5 is a partially schematic view of the detecting device in which the number of the connecting ports is 4;

FIG. 6 is a partially schematic view of the detecting device in which the number of the connecting ports is 6;

FIG. 7 is a schematic view illustrating the connection between the detecting device and the liquid crystal panel in accordance with a first embodiment of the present disclosure;

FIG. 8 is a schematic view illustrating the connection between the detecting device and the liquid crystal panel in accordance with a second embodiment of the present disclosure;

FIG. 9 is a schematic view illustrating the connection between the detecting device and the liquid crystal panel in accordance with a third embodiment of the present disclosure;

FIG. 10 is a schematic view illustrating the connection between the detecting device and the liquid crystal panel in accordance with a fourth embodiment of the present disclosure;

FIG. 11 is a detecting device for detecting a liquid crystal panel in accordance with another embodiment of the present disclosure;

FIG. 12 is a flow chart of a detecting method of a liquid crystal panel in accordance with an embodiment of the present disclosure.

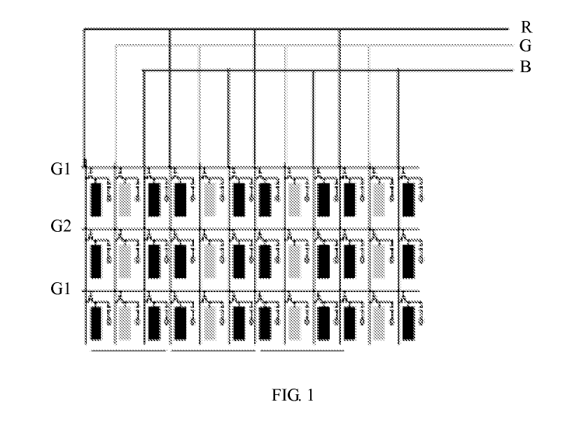

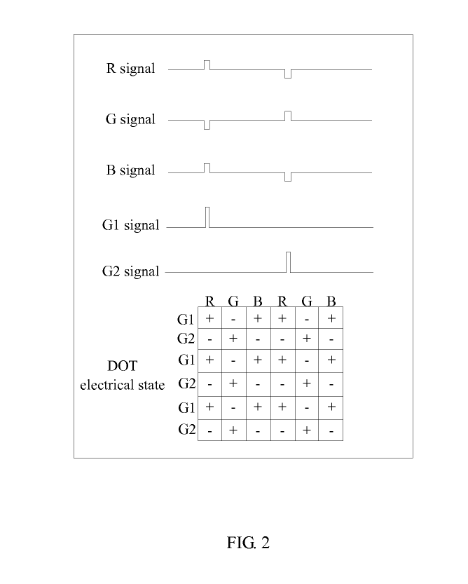

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

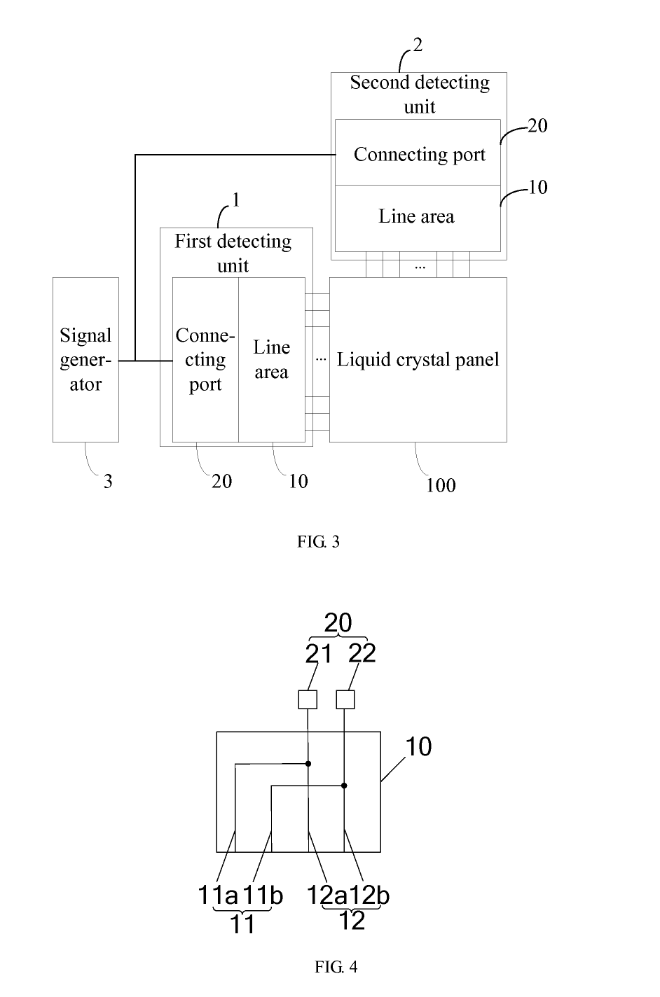

Referring to FIG. 3, a detecting device for detecting a liquid crystal panel in accordance with an embodiment of the present disclosure is schematically shown. The detecting device includes a first detecting unit 1 connected to data lines of a to-be-detected liquid crystal panel 100, a second detecting unit 2 connected to scanning lines of the liquid crystal panel 100, and a signal generator 3 connected to the first detecting unit 1 and the second detecting unit 2. Both the first detecting unit 1 and the second detecting unit 2 include a line area 10 and a number of connecting ports 20 which are arranged on one side of the line area 10 and are connected to the signal generator 3. A number of lines are arranged on the line area 10. The lines which are adjacent to the connecting ports 20 and have the same properties are connected together. One ends of the connected lines are connected to the connecting ports 20 correspondingly, and the other ends of the connected lines which are away from the connecting ports 20 are connected to signal lines disposed on the liquid crystal panel 100.

The detecting device is used for carrying out lighting detection of the liquid crystal panel. The lighting detection way of the liquid crystal panel generally includes 2D1G, 3D2G, 4D2G, 6D2G, 4D4G, and 6D4G, etc. However, detecting the liquid crystal panel in the 2D1G and 3D2G ways may cause two adjacent signals to have the same polarities, which may weaken the detecting ability of the liquid crystal panel. Compared to the 2D1G and 3D2G lighting detection ways, the other four lighting detection ways may improve the detecting ability of the liquid crystal panel. With the detecting device of the present disclosure, the 3D2G or 2D1G lighting detection way can be converted to the other four lighting detection ways. Specifically, a short circuit ring disposed on the liquid crystal panel is at first cut off by laser to suspend the signal lines on the liquid crystal panel in air. One end of the first detecting unit 1 of the detecting device is then connected to the suspended data lines on the liquid crystal panel and the other end thereof is connected to the signal generator 3 via the connecting ports 20. One end of the second detecting unit 2 of the detecting device then is connected to the suspended scanning lines on the liquid crystal panel 100 and the other end thereof is connected to the signal generator 3 via the connecting ports 20. In this way, detecting signals generated by the signal generator 3 can be transmitted to the signal lines on the liquid crystal panel 100 via the connecting ports 20.

With the lines disposed on the line area 10 which has one end thereof configured with the connecting ports 20 for receiving the detecting signals and the other end thereof connected to the signal lines on the liquid crystal panel 100, the detecting device of the present disclosure is capable of converting the lighting detection way of the liquid crystal panel. Additionally, after the lighting detection of the liquid crystal panel is finished, the detecting device can be detached to be recycled, therefore, the circuit which is disposed on the liquid crystal for carrying out the present lighting detection of the liquid crystal panel in the 3D2G or 2D1G way still can be used in the present disclosure, which not only improves the detecting ability of the liquid crystal panel but also sharpens the competitive edge of products having liquid crystal panels.

Furthermore, the lines arranged on the line area 10 of the first detecting unit 1 or the second detecting unit 2 form at least two groups of line units. The lines in each group of line unit are arranged according to property and the sequence of lines in each groups of line unit is identical to each other. Additionally, the number of the lines in each group of line unit is equal to the number of the connecting ports 20. The following specific description about the lines arranged on each line area 10 is based on examples in which the numbers of the connecting ports are respectively 2, 4, and 6.

(1) the number of the connecting ports is 2

Referring to FIG. 4, a detecting device having two connecting ports is partially shown. In the detecting device, the number of the lines arranged on the line area 10 is 2n, wherein n is an integer greater than or equal to 2. Take n being equal to 2 as an example, the connecting ports 20 include a first connecting port 21 and a second connecting port 22, and the lines arranged on the line area 10 form a first line unit 11 and a second line unit 12. On one side of the line area 10, one end of a first line 11a of the first line unit 11 and one end of a first line 12a of the second line unit 12 are connected together on one side of the line area 10, with the first connecting port 21 being connected to the connecting point of the two lines; one end of the second line 11b of the first line unit 11 and one end of the second line 12b of the second line unit 12 are connected together with the second connecting port 22 being connected to the connecting point of the two lines. On the other side of the line area 10, all the suspended end of the lines of the first line unit 11 and the second line unit 12 are respectively connected to the signal lines of the liquid crystal panel.

(2) the number of the connecting ports is 4

Referring to FIG. 5, the detecting device having four connecting ports is partially shown. In the detecting device, the number of the lines arranged on the line area 10 is 4n, wherein n is an integer greater than or equal to 2. Take n being equal to 2 as an example, the connecting ports 20 include a first connecting port 21, a second connecting port 22, a third connecting port 23, and a fourth connecting port 24. The lines arranged on the line area 10 form a first line unit 11 and a second line unit 12. On one side of the line area 10, one end of a first line 11a of the first line unit 11 and one end of a first line 11b of the second line unit 12 are connected together with the first connecting port 22 being connected to the connecting point of the two lines; one end of a second line 11b of the first line unit 11 and one end of a second line 12b of the second line unit 12 are connected together with the second connecting port 22 being connected to the connecting point of the two lines; one end of a third line 11c of the first line unit 11 and one end of a third line 12c of the second line unit 12 are connected together with the third connecting port 23 being connected to the connecting point of the two lines; and one end of a fourth line 11d of the first line unit 11 and one end of a fourth line 12d of the second line unit 12 are connected together with the fourth connecting port 24 being connected to the connecting point of the two lines. On the other side of the line area 10, the suspended ends of the lines of the first line unit 11 and the second line unit 12 are respectively connected to the signal lines on the liquid crystal panel.

(3) the number of the connecting ports is 6

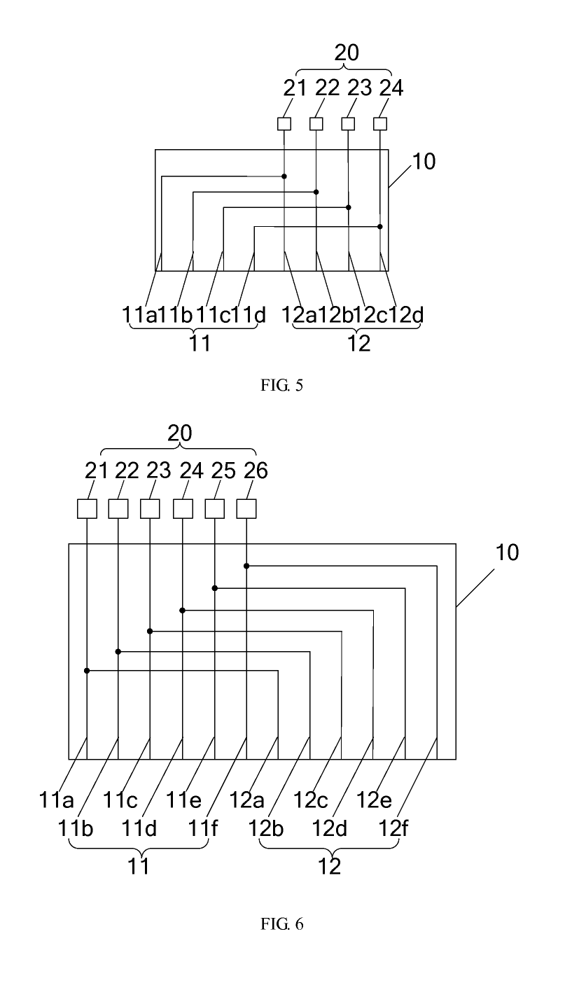

Referring to FIG. 6, the detecting device having six connecting ports is partially shown. The number of the lines arranged on the line area 10 is 6n, wherein n is an integer greater than or equal to 2. Take n being equal to 2 as an example, the connecting ports 20 include a first connecting port 21, a second connecting port 22, a third connecting port 23, a fourth connecting port 24, a fifth connecting port 25, and a sixth connecting port 26. The lines arranged on the line area 10 form a first line unit 11 and a second line unit 12. On one side of the line area 10, one end of a first line 11a of the first line unit 11 and one end of a first line 11b of the second line unit 12 are connected together with the first connecting port 22 being connected to the connecting point of the two lines; one end of a second line 11b of the first line unit 11 and one end of a second line 12b of the second line unit 12 are connected together with the second connecting port 22 being connected to the connecting point of the two lines; one end of a third line 11c of the first line unit 11 and one end of a third line 12c of the second line unit 12 are connected together with the third connecting port 23 being connected to the connecting point of the two lines; one end of a fourth line 11d of the first line unit 11 and one end of a fourth line 12d of the second line unit 12 are connected together with the fourth connecting port 24 being connected to the connecting point of the two lines; one end of a fifth line 11e of the first line unit 11 and one end of a fifth line 12e of the second line unit 12 are connected together with the fifth connecting port 23 being connected to the connecting point of the two lines; and one end of a sixth line 11f of the first line unit 11 and one end of a sixth line 12f of the second line unit 12 are connected together with the sixth connecting port 24 being connected to the connecting point of the two lines.

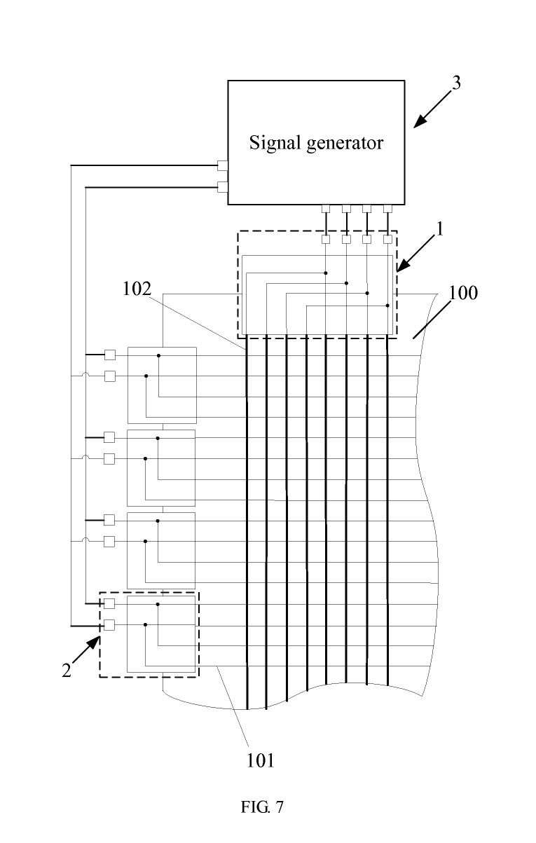

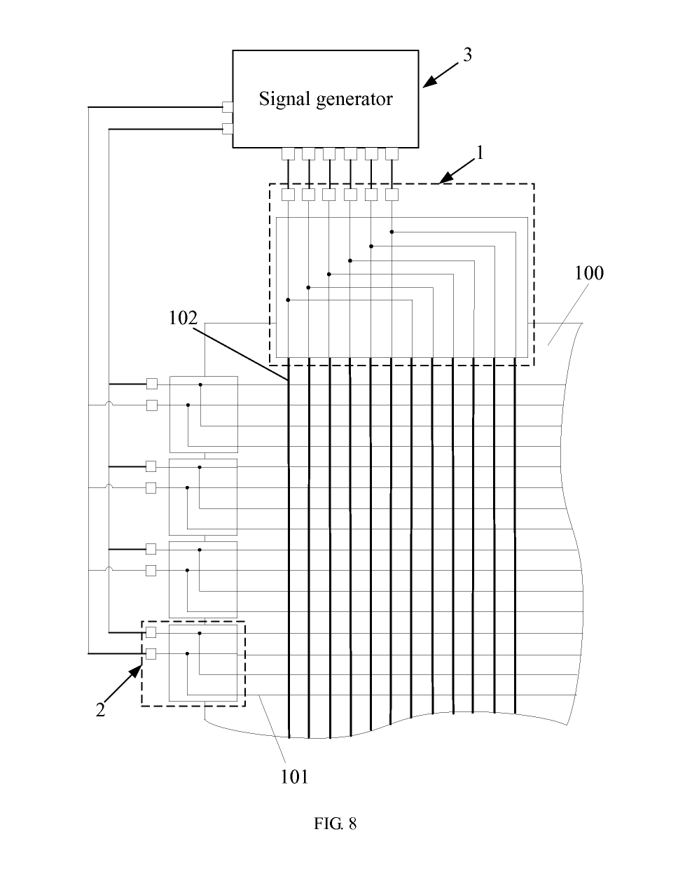

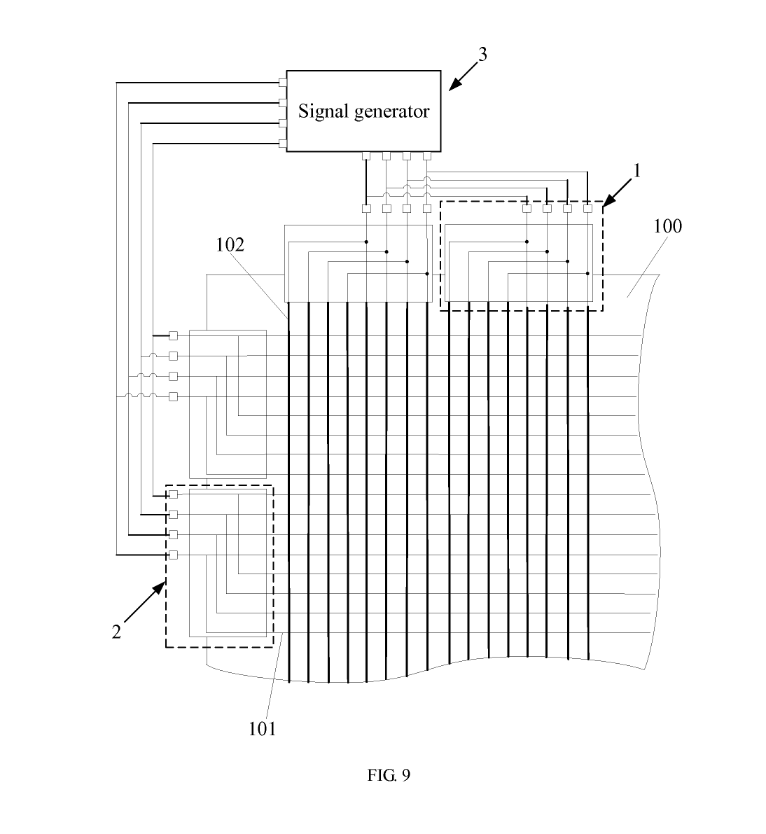

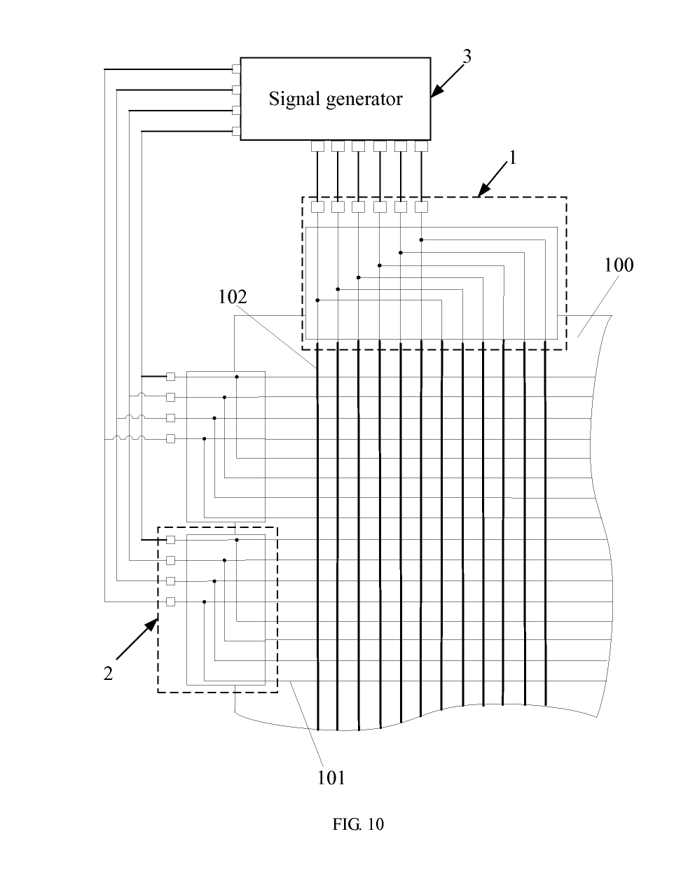

When detecting the liquid crystal panel, detecting devices having different numbers of connecting ports in the first detecting unit and the second detecting unit are respectively connected to the signal lines on the liquid crystal panel to carry out the lighting detection of the liquid crystal panel in the 4D2G, 6D2G, 4D4G, and 6D4G ways. Referring to FIG. 7, in the detecting device used for detecting the liquid crystal panel, the number of the connecting ports of the first detecting unit 1 is 4 and the number of the connecting ports of the second detecting unit is 2, therefore, the lighting detection of the liquid crystal panel can be carried out in the 4D2G way by providing a number of the first detecting units configured in parallel and providing a number of the second detecting units configured in parallel. Referring to FIG. 8, in the detecting device used for detecting the liquid crystal panel, the number of the connecting ports of the first detecting unit 1 is 6 and the number of the connecting ports of the second detecting unit 2 is 2, therefore, the lighting detection of the liquid crystal panel can be carried out in the 6D2G way by providing a number of the first detecting units 1 configured in parallel and a number of the second detecting unit2 2 configured in parallel. Referring to FIG. 9, in the detecting device used for detecting the liquid crystal panel, the number of the connecting ports of the first detecting unit is 4 and the number of the connecting ports of the second detecting unit is 4, therefore, the lighting detection of the liquid crystal panel can be carried out in the 4D4G way by providing a number of the first detecting units 1 configured in parallel and a number of the second detecting unit 2 configured in parallel. Referring to FIG. 10, in the detecting device used for detecting the liquid crystal panel, the number of the connecting ports of the first detecting unit is 6 and the number of the connecting ports of the second detecting unit is 4, therefore, the lighting detection of the liquid crystal panel can be carried out in the 6D4G way by providing a number of the first detecting units 1 configured in parallel and a number of the second detecting unit 2 configured in parallel. According to the above description, it can be concluded that the more the lines respectively arranged on the line areas 10 of the first detecting unit 1 and the second detecting unit 2 are, the less the numbers of the first detecting unit required for detecting the scanning lines 101 on the liquid crystal panel and the second detecting unit used for detecting the data lines 102 on the liquid crystal panel is.

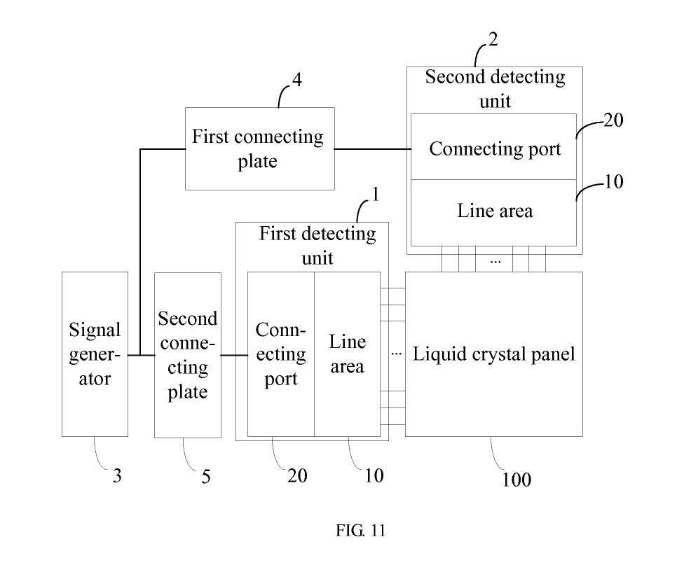

Referring to FIG. 11, the detecting device in accordance with a second embodiment is schematically shown. The detecting device of the embodiment further includes a first transferring plate 4 arranged between the signal generator 3 and the first detecting unit 1 and a second transferring plate 5 arranged between the signal generator 3 and the second detecting unit 2. The first transferring plate 4 and the second transferring plate 5 respectively connect the same type of the connecting ports of the first detecting unit 1 and the second detecting unit 2. Take the number of the connecting ports of the second detecting units being 2 as an example, the second transferring plate 5 is capable of connecting all the first connecting ports 21 and connecting all the second connecting ports 22 on the line area 10. Thus, the signal generated by the signal generator 3 can be transmitted to all the line areas 10 at the same time via the first transferring plate 4 and the second transferring plate 5 and further be transmitted to all the signal lines on the liquid crystal panel at the same time via the line area 10, which finishes the lighting detection of the liquid crystal panel.

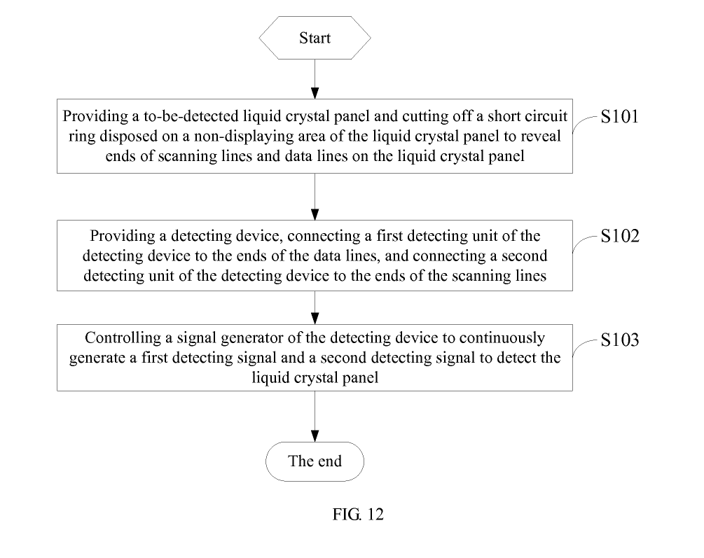

Referring to FIG. 12, a detecting method of a liquid crystal panel in accordance with an embodiment of the present disclosure is provided. The detecting method includes:

Step S101, providing a to-be-detected liquid crystal panel and cutting off a short circuit ring disposed on a non-displaying area of the liquid crystal panel to reveal ends of scanning lines and data lines on the liquid crystal panel.

Step S102, providing a detecting device, connecting a first detecting unit of the detecting device to the ends of the data lines and connecting a second detecting unit of the detecting device to the ends of the scanning lines.

Step S103, controlling a signal generator of the detecting device to continuously generate a first detecting signal and a second detecting signal to detect the liquid crystal panel.

The liquid crystal panel includes an array substrate, a color filter substrate, and a liquid crystal layer arranged between the array substrate and the color filter substrate. A number of data lines, a number of scanning lines intertwined with the data lines, and a number of thin film transistors connected to the data lines and the scanning lines are disposed on a displaying area of the array substrate. A peripheral circuit for driving the thin film transistors to work is arranged on the non-displaying area and connected to the data lines and the scanning lines. In the manufacturing process of the liquid crystal panel, in order to determine that whether the data lines and the scanning lines are normally connected, a short circuit ring is disposed in the peripheral circuit. The short circuit ring can further be used in the lighting detection of the liquid crystal panel after the liquid crystal panel is finished. The lighting detection way of the liquid crystal panel includes a 2D1G, 3D2G, 4D2G, 6D2G, 4D4G, and 6D4G, etc. However, in the detecting process, detecting the liquid crystal panel in the 2D1G and 3D2G ways may cause two adjacent signals to have the same properties, which may weaken the detecting ability of the liquid crystal panel. Compared to the 2D1G and 3D2G lighting detection ways, the other four lighting detection ways may improve the detecting ability of the liquid crystal panel. With the detecting device of the present disclosure, the 3D2G or 2D1G lighting detection way can be converted to the other four lighting detection ways. When the lighting detection is carried out, the short circuit ring disposed on the liquid crystal panel is at first cut off and the detecting device is then connected to the cut signal lines on the liquid crystal panel, which is capable of converting the present 3D2G or 2D1G lighting detection way to the other four lighting detection ways. The detecting device used in the detecting method is the same as the detecting device mentioned in the above embodiments and is not retailed again.

The detecting device of the present disclosure is capable of converting the lighting detection way of the liquid crystal panel. Additionally, the detecting device can be detached to be recycled after the detection is finished, which not only improves the detecting ability of the liquid crystal panel but also reduces the area of the circuit on the liquid crystal panel and further sharpens the competitive edge of the liquid crystal panel.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A detecting device for detecting a liquid crystal panel, wherein the detecting device comprises a first detecting unit connected to data lines on the liquid crystal panel, a second detecting unit connected to scanning lines on the liquid crystal panel, and a signal generator connected to the first detecting unit and the second detecting unit; both the first detecting unit and the second detecting unit comprise a line area and connecting ports arranged on one side of the line area and connected to the signal generator; a plurality of lines are arranged on the line area, the lines having the same properties are connected together with one ends thereof respectively connected to the connecting ports and the other ends thereof connected to the corresponding signal lines arranged on the liquid crystal panel.

2. The detecting device as claimed in claim 1, wherein the lines arranged on the line area form at least two groups of line units, the lines in each group of line unit are arranged according to property and the sequence of the lines in each group of line unit is identical to each other, and the number of the lines in each group of line unit is equal to that of the connecting ports.

3. The detecting device as claimed in claim 2, wherein the number of the connecting ports of the first detecting unit is 4, and the number of the lines arranged on the line area is 4n, wherein n is an integer greater than or equal to 2; the number of the connecting ports of the second detecting unit is 2, the number of the lines arranged on the line area is 2n, wherein n is an integer greater than or equal to 2.

4. The detecting device as claimed in claim 2, wherein the number of the connecting ports of the first detecting unit is 6, and the number of the lines arranged on the line area is 6n, wherein n is an integer greater than or equal to 2; the number of the connecting ports of the second detecting unit is 4, the number of the lines arranged on the line area is 4n, wherein n is an integer greater than or equal to 2.

5. The detecting device as claimed in claim 2, wherein the number of the connecting ports of the first detecting unit is 6, and the number of the lines arranged on the line area is 6n, wherein n is an integer greater than or equal to 2; the number of the connecting ports of the second detecting unit is 2, the number of the lines arranged on the line area is 2n, wherein n is an integer greater than or equal to 2.

6. The detecting device as claimed in claim 2, wherein the numbers of the connecting ports of the first detecting unit and the second detecting unit are respectively 4, the number of the lines arranged on the line area 4n, wherein n is an integer greater than or equal to 2.

7. The detecting device as claimed in claim 2 further comprising a first transferring plate connected between the signal generator and the first detecting unit and a second transferring plate connected between the signal generator and the second detecting unit.

8. The detecting device as claimed in claim 1 further comprising a first transferring plate connected between the signal generator and the first detecting unit and a second transferring plate connected between the signal generator and the second detecting unit.

9. A detecting method for detecting a liquid crystal panel by using the detecting device in claim 1, comprising:
providing a to-be-detected liquid crystal panel and cutting off a short circuit ring disposed on a non-displaying area of the liquid crystal panel to reveal ends of data lines and scanning lines on the liquid crystal panel;
connecting the first detecting unit of the detecting device to the ends of the data lines and connecting the second detecting unit of the detecting device to the ends of the scanning lines; and
controlling the signal generator to continuously generate a first detecting signal and a second detecting signal to detect the liquid crystal panel.

10. The detecting method as claimed in claim 9, wherein the lines arranged on the line areas of the first detecting unit and the second detecting unit form at least two groups of line unit, the lines in each group of line unit are arranged according to property and the sequence of the lines in each group of line unit is identical to each other, and the number of the lines in each group of line unit is equal to that of the connecting ports.

11. The detecting method as claimed in claim 10, wherein the number of the connecting ports of the first detecting unit is 6, and the number of the lines arranged on the line area is 6n, wherein n is an integer greater than or equal to 2; the number of the connecting ports of the second detecting unit is 4, the number of the lines arranged on the line area is 4n, wherein n is an integer greater than or equal to 2.

12. The detecting method as claimed in claim 10, wherein the number of the connecting ports of the first detecting unit is 4, and the number of the lines arranged on the line area is 4n, wherein n is an integer greater than or equal to 2; the number of the connecting ports of the second detecting unit is 2, the number of the lines arranged on the line area is 2n, wherein n is an integer greater than or equal to 2.

13. The detecting method as claimed in claim 10, wherein the number of the connecting ports of the first detecting unit is 6, and the number of the lines arranged on the line area is 6n, wherein n is an integer greater than or equal to 2; the number of the connecting ports of the second detecting unit is 2, the number of the lines arranged on the line area is 2n, wherein n is an integer greater than or equal to 2.

14. The detecting method as claimed in claim 10, wherein the numbers of the connecting ports of the first detecting unit and the second detecting unit are respectively 4, the number of the lines arranged on the line area 4n, wherein n is an integer greater than or equal to 2.

15. The detecting method as claimed in claim 10, wherein the detecting device further comprises a first transferring plate disposed between the signal generator and the first detecting unit and a second transferring plate disposed between the signal generator and the second detecting unit.

16. The detecting method as claimed in claim 9, wherein the detecting device further comprises a first transferring plate disposed between the signal generator and the first detecting unit and a second transferring plate disposed between the signal generator and the second detecting unit.
